(19) United States
(12) Patent Application Publication
(10) Pub. No.: US 2017/0017193 A1
(43) Pub. Date: Jan. 19, 2017

(54) DEVICE FOR CLEANING A PHOTOCONDUCTOR IN A PRINTER OR COPIER

(71) Applicant: Oce Printing Systems GmbH & Co. KG, Poing (DE)

(72) Inventors: Ludwig Kettenberger, Erding (DE); Stefan Mayr, Reichertshausen (DE); Jochen Reinders, Muenchen (DE)

(73) Assignee: Oce Printing Systems GmbH & Co. KG, Poing (DE)

(21) Appl. No.: 15/210,085

(22) Filed: Jul. 14, 2016

(30) Foreign Application Priority Data
Jul. 17, 2015 (DE) 102015111615.4

(51) Int. Cl. G03G 21/00

(52) U.S. Cl. CPC G03G 21/0011

(57) ABSTRACT

A device adapted to clean a photoconductor. The device can include a blade and an absorbent element. The absorbent element can be made from an absorbent material. The absorbent element can be arranged in front of the blade as viewed in the movement direction.

### CROSS REFERENCE TO RELATED APPLICATIONS

This patent application claims priority to German Patent Application No. 102015111615.4, filed Jul. 17, 2015, which is incorporated herein by reference in its entirety.

### BACKGROUND

The disclosure is directed to a device for cleaning a photoconductor in a printer or copier. The device can include, for example, a blade that has an active edge. The active edge can be configured to contact the photoconductor. Via this contact, the blade can clean off carrier fluid, toner residues or other contaminants from the photoconductor.

In electrophotographic printing systems (for example copiers or printers), the print image is transferred from a photoconductor onto a transfer roller or directly onto the printing substrate. After the print image has been transferred, the carrier fluid remaining on the photoconductor and/or the toner residues remaining on the photoconductor is cleaned off of the photoconductor so that a print image may subsequently be applied again with high quality onto the photoconductor.

Blades that have an active edge made from an elastomer can be used for cleaning off the carrier fluid and the toner residues. This active edge wipes across the photoconductor and thus cleans off the carrier fluid and the toner residues.

Such blades are disadvantageous in that over time contaminants (for example corona products from the charging, toner particles, resins and waxes) nevertheless deposit on the photoconductor in spite of the blade, which contaminants form a non-uniform film on the photoconductor. This film may negatively affect the print quality. In particular, such a film influences both the charging process and the discharging process since the absorption of the radiation from the character generator and/or erasure light changes, and this thus leads to inhomogeneities in the discharge level or charge level of the latent print image. The character sharpness may also be negatively affected by the different optical refraction in the film.

Regularly manually cleaning of the photoconductor with corresponding solvents (for example acetone or isopropanol) can be performed to remove this film. What is disadvantageous in this is that a large effort is linked with this, and there is a high risk of damaging the expensive photoconductor. Moreover, the machine downtime that is necessary for this incurs additional costs.

The active edge blade also wears quickly where the active edges are formed from an elastomer. Due to the high coefficient of friction, the active edges require a minimum quantity of fluid in order to be protected from dry running. If such a dry running occurs (i.e., insufficient fluid is arranged between the active edge and the photoconductor), this leads to damage to the active edge, which subsequently prevents a uniform, reliable cleaning process. Given the conventional blades, the fluid which should be cleaned off (thus in particular the carrier fluid) thus serves simultaneously for cooling and lubrication of the active edge and thus protects this from excessive wear. However, it is problematic that the fluid is often not regularly distributed on the photoconductor, and thus may lead to a partial wear. In particular in the side regions of the blade, sufficient fluid is often not present, such that it is precisely the sides of the active edge that wear very quickly. These side effects are intensified in that the active edge is often designed to be wider than the print image in order to ensure a reliable cleaning even given certain tolerances.

Devices for cleaning off carrier fluid and toner residues from a photoconductor are described in for example, U.S. Pat. No. 8,805,233 B2, US 2014/0087295 A1 and U.S. Pat. No. 6,438,352 B1.

Further, DE 60 2005 001 124 T2, DE 699 18 595 T2 and DE 693 13 245 T2 respectively described devices for the cleaning of a photoconductor in which the cleaning takes place on the one hand via a blade and on the other hand via a sponge roll arranged in front of the blade.

Additional devices for the cleaning of a photoconductor are descried in, for example, US 2014/0140722 A1, U.S. Pat. No. 5,502,547 A, U.S. Pat. No. 8,805,233 B2 and DE 92 13 225 Ul.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a photoconductor, a transfer roller, a developer roller and a device for cleaning the photoconductor according to an exemplary embodiment of the present disclosure.

FIG. 2 illustrates a photoconductor, a transfer roller, a developer roller and a device for cleaning the photoconductor according to an exemplary embodiment of the present disclosure.

FIG. 3 illustrates a photoconductor, a transfer roller, a developer roller and a device for cleaning the photoconductor according to an exemplary embodiment of the present disclosure.

FIG. 4 illustrates an enlarged view of portions of the photoconductor, blade, and absorbent element according to one or more exemplary embodiments of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the disclosure is to provide a device for cleaning a photoconductor in a printer or copier, with the aid of which device a reliable cleaning of the photoconductor is achieved and which device has low-wear.

According to embodiments of the disclosure, an absorbent element made from an absorbent material can be arranged before the blade (as viewed in the movement direction of the photoconductor), which absorbent element contacts the photoconductor. Via the contact of the photoconductor with this absorbent material, the film forming on the photoconductor is cleaned off by the absorbent material so that the buildup of such an interfering film is avoided, and thus a high print quality is achieved without the necessity of manual cleaning processes. Moreover, a uniform distribution of the fluid (in particular the carrier fluid) located on the photoconductor over the entire width of the absorbent element is achieved via the absorbent element, such that a predetermined minimum fluid quantity in front of the active edge is always ensured, such that a dangerous dry running of the blade which would lead to damage to said blade is avoided. In particular, fluid is also transported into the side regions of the blade via this transversal distribution of the fluid via the absorbent element, such that the side regions of the active edges of the blade are also always sufficiently lubricated and thus are protected against damage.

In an exemplary embodiment, an element that takes up and stores fluid may be used as an absorbent element.

In an exemplary embodiment, the absorbent element has a predetermined storage capacity for the fluid, such that—even if fluid is no longer transferred onto the photoconductor given an interruption of the printing, thus if the external fluid supply is interrupted, for example given disruptions or transition processes, thus if no new print image is transferred for a long time—the active edge of the blade is nevertheless sufficiently lubricated by the fluid dispensed from the absorbent element, and thus a dry running (and damage to the blade that is hereby incurred) is avoided.

In an exemplary embodiment where the arrangement of the absorbent element in front of the blade, contaminants that remain on the photoconductor after the transfer of the print image (thus in particular carrier fluid and toner residues) are first transported to the absorbent element or directed past this and are subsequently transported to the active edge of the blade insofar as they have not been accordingly taken up by the absorbent element. The absorbent element is thus in particular arranged upstream of the blade.

In an exemplary embodiment, the absorbent element is manufactured from felt. Felt offers a sufficient absorption capacity and also a gentle cleaning of the photoconductor.

In an exemplary embodiment, the absorbent element is a felt strip such that the absorbent element may be produced particularly simply and cost-effectively.

In an exemplary embodiment of the present disclosure, the absorbent element is attached to the blade. An edge of the absorbent element that contacts the photoconductor can accordingly projects beyond the blade so that it contacts the photoconductor before the active edge of the blade. It is hereby achieved that the blade and the absorbent element may be installed and exchanged together in a particularly simple manner. Moreover, a particularly compact design is realized. In an alternative embodiment of the disclosure, the absorbent element may also be arranged at a predetermined distance in front of the blade.

In an exemplary embodiment of the present disclosure, the absorbent element has at least the same width as the active edge of the blade. In this example, the fluid absorbed by the absorbent element is distributed via the absorbent element across the entire width of the active edge, such that the active edge is protected against dry running (and damage that is hereby incurred) over its entire width.

In an exemplary embodiment, the absorbent element contacts the photoconductor with one of its edges. Alternatively, the absorbent element may also contact the photoconductor over an area. In an exemplary embodiment, the active edge of the blade is made from an elastomer. In this example, a necessary stability and a sufficient deformability to avoid damage to the photoconductor are achieved. On the other hand, active edges made from such elastomers have good wiping properties.

In an exemplary embodiment, the active edge of the blade is made from a nonabsorbent material.

In an exemplary embodiment, relative to the movement direction of the photoconductor, the absorbent element contacts the photoconductor between those regions at which the print image is transferred to the transfer roller or the printing substrate and that region in which the active edge of blade contacts the photoconductor.

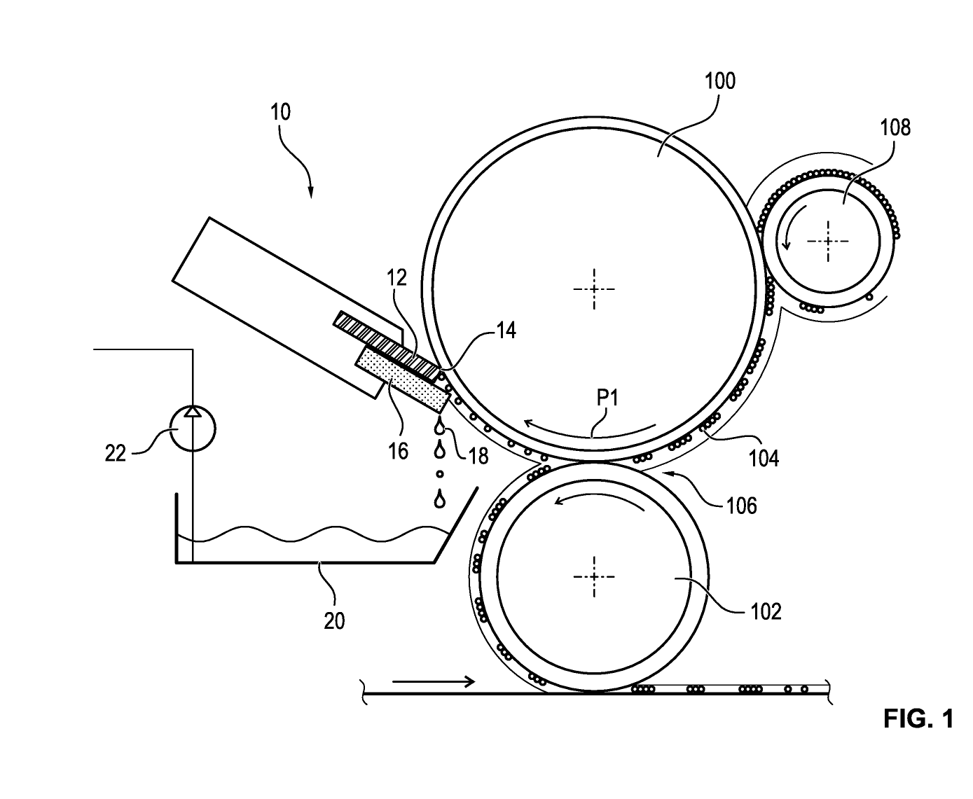

FIG. 1 illustrates an electrophoretic print group with a photoconductor 100, a transfer roller 102, a developer roller 108 and a device 10 for cleaning the photoconductor 100.

In an exemplary embodiment, a developer fluid that includes toner particles and carrier fluid is applied into the developer roller 108. The toner particles of the print image and a portion of the carrier fluid are applied from the developer roller 108 onto the photoconductor 100, corresponding to the latent image on the photoconductor 100. In a transfer region 106, toner particles as well as a portion of the carrier fluid are transferred from the photoconductor 100 onto the transfer roller 102, which then transfers the print image onto the printing substrate (not shown).

After the transfer of the print image onto the transfer roller 102, a small portion of the toner may remain on the photoconductor 100. The carrier fluid also likewise remains at least in part on the photoconductor 100. The mixture of fluid and toner that remains on the photoconductor 100 downstream of the transfer region 106 is cleaned off from this with the aid of a device 10 configured to clean the photoconductor 100.

In an exemplary embodiment, the device 10 includes a blade 12 that has an active edge that contacts the photoconductor 100. The contaminants (in particular the remaining carrier fluid and the remaining toner particles) are cleaned off of the photoconductor 100 and carried away in a controlled manner via this contact with the photoconductor 100.

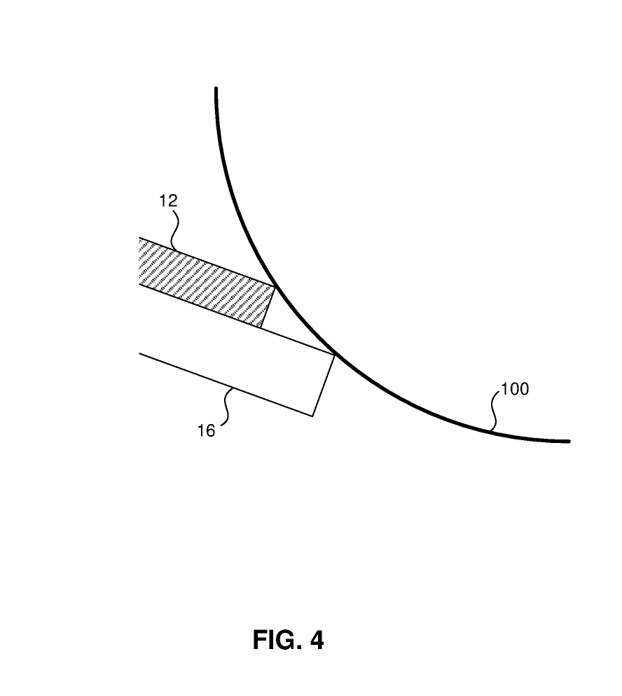

In an exemplary embodiment, arranged in front of the active edge 14 is a felt strip 16 that contacts the photoconductor 100 before (relative to the movement direction P1 of the photoconductor 100) the active edge 14, thus between the transfer region 106 and the active edge 14. The fluid located on the photoconductor 100 is dammed up by the blade 12 in the direction of the felt strip 16 so that an additional cleaning effect on the photoconductor 100 is executed by this dammed-up fluid. The dammed-up fluid is absorbed by the felt strip 16 and distributed so that the blade 12 is dampened and does not run “dry.” The toner is hereby better cleaned off by the blade 12. Although the felt strip 16 is spaced apart from the photoconductor 100 in FIGS. 1-3, the felt strip 16 contacts the photoconductor 100 in one or more exemplary embodiments. This contacting arrangement is illustrated in FIG. 4, which is an enlarged view of the configuration of the felt strip 16, the blade 14 and the photoconductor 100 according to one or more exemplary embodiments.

In an exemplary embodiment, via the absorbent effect of the felt strip 16, the fluid is also uniformly distributed over the entire width of the felt strip 16, whereby a wetting of the blade 12 and/or of the photoconductor 100 takes place. In an exemplary embodiment, some of the fluid is also dispensed onto the photoconductor 100 again by the felt strip 16 such that some fluid is supplied again to this photoconductor 100 over, for example, its entire width. This can avoid a dry running of the active edge 14 (and damage that is hereby incurred). Moreover, the felt strip 16 advantageously stores fluid that was already supplied beforehand and continues to dispense it onto the photoconductor 100 even when no new fluid is supplied to it for a period of time, such that the active edge 14 continues to be supplied with fluid even without the external feed of additional fluid, and thus a dry running is avoided at least for a period of time.

In an exemplary embodiment of the present disclosure, the blade 12 and the felt strip 16 can rest and butt against the photoconductor 100 (i.e. counter to the running direction). In an alternative embodiment, the blade 12 and the felt strip 16 can rest trailing on the photoconductor 100 (i.e. in the running direction).

In an exemplary embodiment, the geometry of the felt strip 16 is configured such that the excess fluid does not run back onto the photoconductor 100 after the fluid capacity of the felt strip 16 is reached. In this example, the excess fluid drips into a capture pan 20 either directly from the edge of the felt strip 16, or in a controlled manner via a drain edge 18 located directly beneath it. The cleaned-off fluid may be disposed of from this capture pan 20 with the aid of a pump 22.

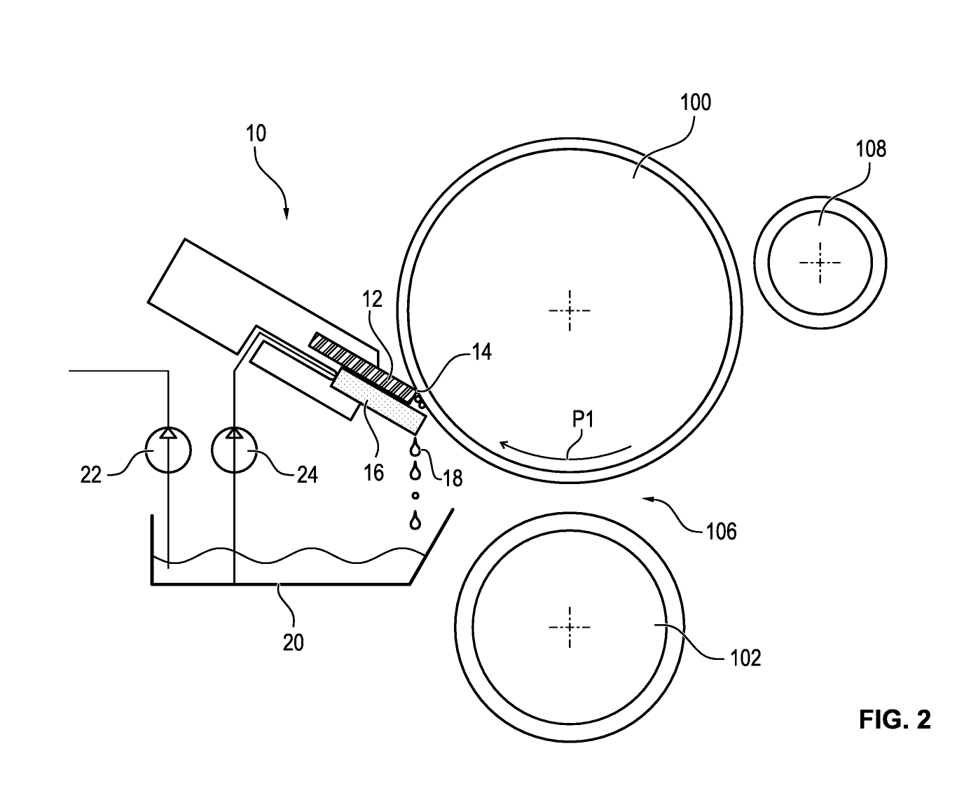

FIG. 2 illustrates a section of a printer or copier according to an exemplary embodiment of the present disclosure. Elements with the same design and with the same function have the same reference characters and discussion may have been omitted for brevity.

In an exemplary embodiment, an additional pump 24 is provided with which the cleaned-off fluid is supplied out of the capture pan 22 to the felt strip 16 again in a controlled manner. In this example, the fluid supplied by the pump 24 wets (e.g., dampens, moistens, saturates, soaks, or another degree of wetting) the felt strip 16. It is hereby achieved that a dry running is avoided and a sufficient cleaning is always provided, even given longer times without passive supply with fluid, thus if the felt strip 16 does not absorb any fluid for a longer period of time. In particular, the deposition of corona salts and a “blurring” that is hereby caused are avoided.

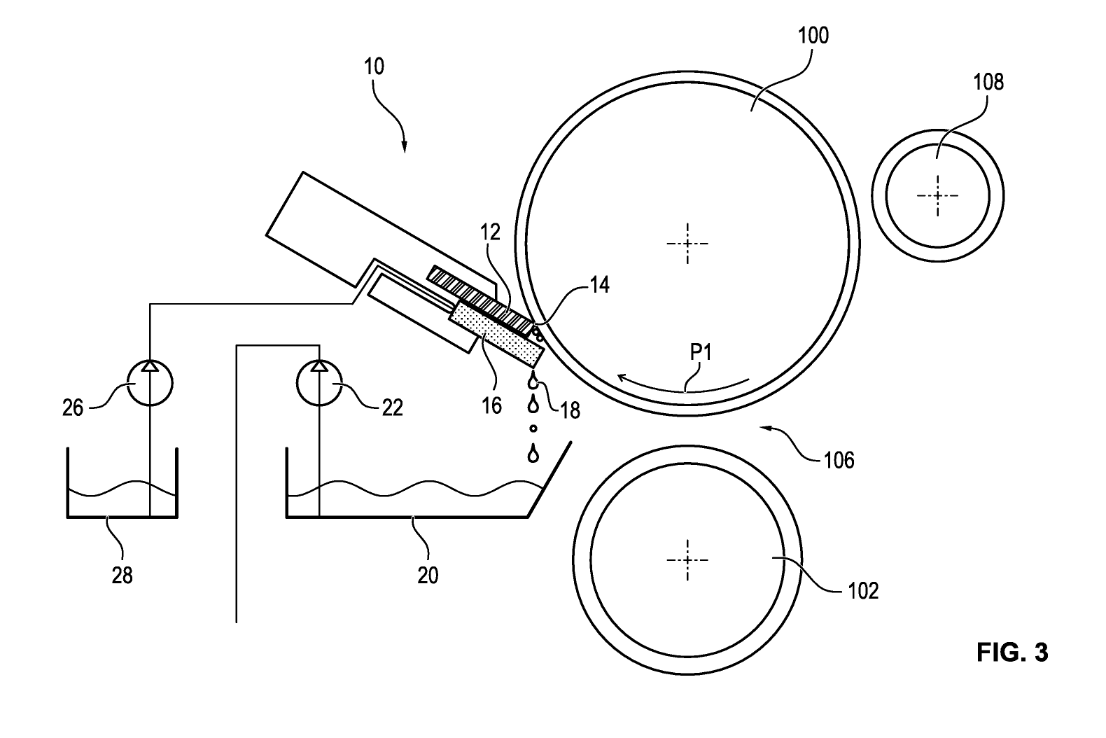

FIG. 3 illustrates a printer or copier according to an exemplary embodiment of the present disclosure. In this example, the fluid is supplied to the felt strip 16 not from the capture pan 20 but rather from a separate fluid reservoir 28 with the aid of a pump 26. For example, the supplied fluid may be fresh carrier fluid or a special cleaning fluid. This embodiment has the advantage that pure fluid (thus without toner particles) may be supplied from the fluid reservoir. A clogging of the felt strip 16 with toner particles is thus reduced and/or avoided. In this example, the fluid supplied by the pump 26 wets (e.g., dampens, moistens, saturates, soaks, or another degree of wetting) the felt strip 16.

In an exemplary embodiment, a nozzle system is provided which uniformly supplies the felt strip 16 with the supplied fluid.

In an exemplary embodiment, an alternative absorbent material (for example foamed material or non-woven fabric) may be used instead of a felt strip 16.

In the exemplary embodiments shown in FIGS. 1-3, the felt strip 16 is respectively attached to the blade 12. In an exemplary embodiment, the felt strip 16 is arranged at a predetermined distance in front of the blade 12. In an exemplary embodiment, the felt strip 16 is spaced apart from the blade 12.

In one or more exemplary embodiments, the printing system includes a controller configured to control the operation of the pump 22, pump 24, and/or pump 26. In an exemplary embodiment, the controller includes processor circuitry configured to perform the operations and/or functions of the controller.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

For the purposes of this discussion, processor circuitry can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein. In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

10 device
12 blade
14 active edge
16 felt strip
18 drain edge
20 capture pan
22, 24, 26 pump
28 container
100 photoconductor
102 transfer roller
104 developer mixture
106 transfer region
108 developer roller
P1 movement direction

What is claimed is:

1. A device adapted to clean a photoconductor in an electrophoretic printer or copier, the device comprising:
a blade having an active edge that contacts the photoconductor to clean carrier fluid and/or toner residues off of the photoconductor; and
an absorbent element made from an absorbent material and attached to the blade, the absorbent element being configured to contact the photoconductor and being arranged in front of the blade in a movement direction of the photoconductor,
wherein the absorbent element is at least as wide as the active edge of the blade, and
wherein an edge of the absorbent element that contacts the photoconductor projects beyond the blade so that the edge of the absorbent element contacts the photoconductor before the active edge of the blade.

2. The device according to claim 1, wherein the absorbent element is felt.

3. The device according to claim 2, wherein the absorbent element is a felt strip.

4. The device according to claim 1, wherein the absorbent element contacts the photoconductor over an area.

5. The device according to claim 1, wherein at least the active edge of the blade is comprised of an elastomer.

6. The device according to claim 1, wherein, relative to the movement direction of the photoconductor, the absorbent element contacts the photoconductor between a region at which the print image is transferred onto a transfer roller and a region in which the active edge of the blade contacts the photoconductor.

7. The device according to claim 1, wherein the edge of the absorbent element is arranged between a transfer region and the active edge of the blade relative to the movement direction.

8. The device according to claim 1, wherein the blade is configured to dam up the carrier fluid and/or toner residues on the photoconductor in a direction of the absorbent element.

9. The device according to claim 1, further comprising:
a pump configured to supply a fluid to the absorbent element to wet the absorbent material.

10. The device according to claim 9, wherein the fluid is the carrier fluid and/or toner residues having been cleaned off of the photoconductor.

11. The device according to claim 9, wherein the fluid is a fresh carrier fluid.

12. The device according to claim 9, wherein the fluid is a cleaning fluid.

13. The device according to claim 9, further comprising a controller configured to control the pump to supply the fluid to the absorbent element.

14. A device adapted to clean a photoconductor in an electrophoretic printer or copier, the device comprising:
a blade having an active edge that contacts the photoconductor, the blade being configured to clean residue off of the photoconductor; and
an absorbent element arranged adjacent to the blade, wherein an edge of the absorbent element projects beyond the active edge of the blade and contacts the photoconductor such that the edge of the absorbent element is closer than the active edge of the blade to a transfer region of the photoconductor in a movement direction of the photoconductor.

15. The device according to claim 14, wherein the absorbent element is at least as wide as the active edge of the blade.

16. The device according to claim 14, wherein the absorbent element is a felt strip.

17. The device according to claim 14, wherein the active edge of the blade is comprised of an elastomer.

18. The device according to claim 14, wherein the edge of the absorbent element contacts the photoconductor before the active edge of the blade contacts the photoconductor relative to the movement direction of the photoconductor.

19. The device according to claim 14, wherein the blade is configured to dam up the carrier fluid and/or toner residues on the photoconductor in a direction of the absorbent element.

20. The device according to claim 14, further comprising:
a pump configured to supply a fluid to the absorbent element to wet the absorbent material, wherein the fluid is:
the carrier fluid and/or toner residues having been cleaned off of the photoconductor,
a fresh carrier fluid, or
a cleaning fluid.
